(19) United States
(12) Patent Application Publication
(10) Pub. No.: US 2026/0116446 A1
(43) Pub. Date: Apr. 30, 2026

(54) MULTI-PURPOSE CART

(71) Applicants: Joseph Cece, Venice, FL (US); Grace Cece Colona, Venice, FL (US)

(72) Inventors: Joseph Cece, Venice, FL (US); Grace Cece Colona, Venice, FL (US)

(21) Appl. No.: 18/932,753

(22) Filed: Oct. 31, 2024

(51) Int. Cl. B62B 3/02; B62B 3/00; B62B 5/06; B62K 27/00; B62K 27/02; B62K 27/04

(52) U.S. Cl. CPC B62B 3/02; B62B 3/002; B62B 5/06; B62K 27/003; B62K 27/02; B62K 27/04; B62B 2301/14; B62B 2501/06

(57) ABSTRACT

A multi-purpose cart includes a frame that defines a volume. At a bottom rear of the frame there are rear wheels disposed on opposite sides of the frame. One or more freely turning front wheels are located at the front of the frame. The bottom or floor of the frame is sloped downward from front to back to encourage placing items into the frame towards the back of the frame. A handle extension is provided at the rear of the cart that alternatively allows connection of a handle to facilitate pushing the multi-purpose cart by a person, as well as to connect to a towing assembly to allow the multi-purpose cart to be towed behind a bicycle and maintain the multi-purpose cart in a tilted position so that the rear wheels remain on the ground and the front wheels are raised above, and not touching the ground.

### FIELD OF THE INVENTION

The present invention relates generally to utility carts, and, more particularly, relates to a dual-purpose cart that is trailerable behind a bicycle and is also configured to act as a push cart for use by a person for activities such as shopping.

### BACKGROUND OF THE INVENTION

There are many types of carts in use today, for a wide variety of applications. Carts, in general, carry a load that a person either could not carry, or would be uncomfortable carrying so that the person can move the load around. The load can be anything from industrial equipment to groceries to infants or pets, among many other examples. Among the various types of carts used by people, shopping carts are among the most commonly used cart. The are carts typically provided by at a shopping location (e.g. a store) for shoppers to use to select and collect items to purchase, and in many cases to push the purchased goods to their vehicle for transfer to the vehicle. In some cases, the vehicle may be a bicycle, in which case the bicycle needs some means to hold and carry items, such as baskets or a bicycle trailer.

Shopping carts represent a substantial asset cost to merchants in both initial outlay, as well as maintenance and replacement costs. There is also a labor cast associated with have to retrieve shopping carts from parking lots and move them back to the store so that other shoppers can use them. Of course, these costs are figured into product pricing. Being able to reduce, if not eliminate the need to provide shopping carts. At the same time, carrying groceries from a store to the home on a bicycle either involves adding weight to the bicycle by loading baskets that are directly attached to the bicycle, potentially making the bicycle more difficult to control, or placing the groceries into some form of a bicycle trailer. However, bicycle trailers are often unwieldy and not pleasant to pull behind a bicycle.

Therefore, a need exists to overcome the problems with the prior art as discussed above.

### SUMMARY OF THE INVENTION

In accordance with some embodiments of the inventive disclosure, there is provided a multi-purpose cart that is capable of being used as a push cart in one usage mode, and as a trailer in another usage mode. The multi-purpose cart include a frame that defines the “basket” of the cart into which items can be placed and carried in the cart. The frame specifically defines a first side, a second side that is opposite the first side, a front end, a rear end that is opposite the front end. The first side and the second side each extend from the front end to the rear end. The frame also defines a bottom, and the top of the frame is open. Thus, items can be placed into the frame through the top, where they will rest on the bottom of the frame, or on a panel on the bottom of the frame. The cart further includes a first rear wheel disposed at a bottom of the first side at the rear end, and a second rear wheel disposed at a bottom of the second side at the rear end and opposite the first rear wheel. There is also a front wheel assembly including at least one front wheel at a bottom of the front end which is configured to freely turn in a horizontal direction to facilitate steering of the cart when the cart is used as a push cart. There is also a handle extension which extends from a top of the rear end of the frame. The handle extension allows coupling to either a handle for pushing the cart, or a trailering arm for towing the cart. The bottom of the frame slopes downward in a direction from the front end to the rear end, relative to the multi-purpose cart being on a level surface with the at least one front wheel and the first and second rear wheels being on the level surface. This configuration encourages the user to place items to the back of the frame in order to keep weight closer to the rear wheels so that when the cart is used as a trailer, the weight distribution will not cause unwanted oscillations or other actions in the cart.

In accordance with a further feature, the at least one front wheel extends downward, relative to the frame, further than the first and second rear wheels.

In accordance with a further feature, the handle extension has a distal end that is configured to couple to a handle and to a trailering arm, wherein the handle is used when the multi-purpose cart is used as a push cart, and wherein the trailering arm is used to pull the multi-purpose cart as a trailer and wherein the trailering arm holds the multi-purpose cart such that the at least one front wheel does not touch ground.

In accordance with a further feature, the frame is comprised of a plurality of tubular members including at least one front vertical member, and a first rear vertical member defining a first corner where the first side and the rear end meet, and a second rear vertical member that is opposite the first rear vertical member and which defines a second corner where the second side and the rear end meet.

In accordance with a further feature, there is further included a mesh panel that covers the bottom of the frame.

In accordance with a further feature, there is further included at least one mesh panel on the first side of the frame, at least one mesh panel on the second side of the frame, at least one mesh panel on the front end of the frame, and at least one mesh panel on the rear end of the frame.

In accordance with a further feature, the front wheel assembly comprises two front wheels disposed on opposite sides of an armature that is connected to a front bottom cross member of the frame via a pivot assembly.

In accordance with some embodiments of the inventive disclosure, there is provided a multi-purpose cart system including a multi-purpose cart that can be used in a first mode as a push cart and in a second mode as a bicycle trailer. The system includes a multi-purpose cart that has a frame that defines is used to carry items. The frame has a first side, a second side that is opposite the first side, a front end, a rear end that is opposite the front end. The first side and the second side extend from the front end to the rear end. The frame also has a bottom between the bottoms of the first and second sides and front and rear ends. The top of the frame is open to allow items to be placed into the frame to carry them. The cart also includes a first rear wheel disposed at a bottom of the first side at the rear end and a second rear wheel disposed at a bottom of the second side at the rear end and opposite the first rear wheel. There is also a front wheel assembly including at least one front wheel at a bottom of the front end, which is configured to freely turn in a horizontal direction to facilitate steering the cart when the cart is used as a push cart. There is also a handle extension which extends from a top of the rear end. The system also includes a handle that is configured to attach to a distal end of the handle extension when the multi-purpose cart is used as a push cart. The system also includes a trailering arm that is configured to couple to the distal end of the handle extension at a first end of the trailering arm, and also to a bicycle at a second end of the trailering arm, when the multi-purpose cart is used as a bicycle trailer. The trailering arm maintains the multi-purpose cart in a tilted orientation such that only the first and second rear wheels make contact with a ground surface (e.g. the front wheels do not) over which the multi-purpose cart is pulled.

In accordance with a further feature, the bottom of the frame slopes downward in a direction from the front end to the rear end relative to the multi-purpose cart being on a level surface with the at least one front wheel and the first and second rear wheels being on the level surface.

In accordance with a further feature, the at least one front wheel extends downward, relative to the frame, further than the first and second rear wheels.

In accordance with a further feature, the frame is comprised of a plurality of tubular members including at least one front vertical member, and a first rear vertical member defining a first corner where the first side and the rear end meet, and a second rear vertical member that is opposite the first rear vertical member and which defines a second corner where the second side and the rear end meet.

In accordance with a further feature, there is further included a mesh panel that covers the bottom of the frame.

In accordance with a further feature, there is further included at least one mesh panel on the first side of the frame, at least one mesh panel on the second side of the frame, at least one mesh panel on the front end of the frame, and at least one mesh panel on the rear end of the frame.

In accordance with a further feature, the front wheel assembly comprises two front wheels disposed on opposite sides of an armature that is connected to a front bottom cross member of the frame via a pivot assembly.

In accordance with a further feature, the frame of the multi-purpose cart includes locking hinges that lock the frame in an unfolded state for use as a push cart and as a trailer, and which unlock to allow the frame to be folded for storage.

Although the invention is illustrated and described herein as embodied in a multi-purpose cart, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance. Similarly, terms such as “vertical” and “horizontal” are used in reference to an ordinary orientation of the article being described. Herein, specifically, these terms refer to the vertical and horizontal orientations relative to the ground surface when the described multi-purpose cart is used as a push cart with both the front and rear wheels on a level surface. In embodiments where the cart is tilted towards the rear, the various frame members are still either mostly vertical of mostly horizontal.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the article being referenced or described. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1A a side elevational view of a multi-purpose cart, in accordance with some embodiments.

FIG. 1B is a rear elevational view of the multi-purpose cart, in accordance with some embodiments.

FIG. 2 is a side elevational view of the multi-purpose cart on a level surface, in accordance with some embodiments.

FIG. 3 is a top plan view of the multi-purpose cart, in accordance with some embodiments.

FIG. 4 is a perspective view of the multi-purpose cart, in accordance with some embodiments.

FIG. 5 is a top plan view of a mesh bottom panel attached to the lower frame members of the multi-purpose cart, in accordance with some embodiments.

FIG. 6 is a perspective view of the multi-purpose cart with the mesh bottom panel installed, in accordance with some embodiments.

FIG. 7A is a side elevational view of the multi-purpose cart resting on a level surface, for use as a cart, in accordance with some embodiments.

FIG. 7B is side elevational view of the multi-purpose cart tilted, for use as a trailer, in accordance with some embodiments.

FIG. 8 shows the multi-purpose cart used as a bicycle trailer, in accordance with some embodiments.

FIGS. 9A and 9B show perspective view of the multi-purpose cart with different handle types for pushing the multi-purpose cart, in accordance with some embodiments.

FIG. 10 shows top plan views of a multi-purpose cart that is configured to fold, in an unfolded state and a folded state, in accordance with some embodiments.

FIG. 11 shows a locking hinge for connecting frame members of a multi-purpose cart that allow the multi-purpose cart to be folded as well as locked into an unfolded state for use, in accordance with some embodiments.

FIG. 12 shows a side elevational view of a multi-purpose cart having a sloping bottom, in accordance with some embodiments.

FIG. 13 shows a side elevational view of a multi-purpose cart that can be adjusted so that the frame of the cart is level when used as a push cart, in accordance with some embodiments.

FIG. 14 shows a perspective view of a multi-purpose cart in which a frame liner bag is used to line the frame and contain items within the frame, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present inventive disclosure provides a novel and efficient multi-purpose cart that can be pushed when in a first usage mode, and it can be used as a trailer in a second usage mode. When used as a trailer, the multi-purpose cart can be pulled behind a bicycle or similar mode of transportation. Further, when used as a trailer, multi-purpose cart is configured to be tilted such that the front wheel are off the ground, and tilted substantially to move the center of gravity back toward the rear wheels, which remain on the ground. This makes pulling the cart as a trailer behind a bicycle much easier. Thus, a user can pull the cart, as a trailer, to a grocery store, for example, and then detach the multi-purpose cart from the bicycle and used the multi-purpose cart to collect groceries in the store, and then re-attach the multi-purpose cart to the bicycle and haul the groceries home. This is one use case example, and the multi-purpose cart can be used for other purposes as well.

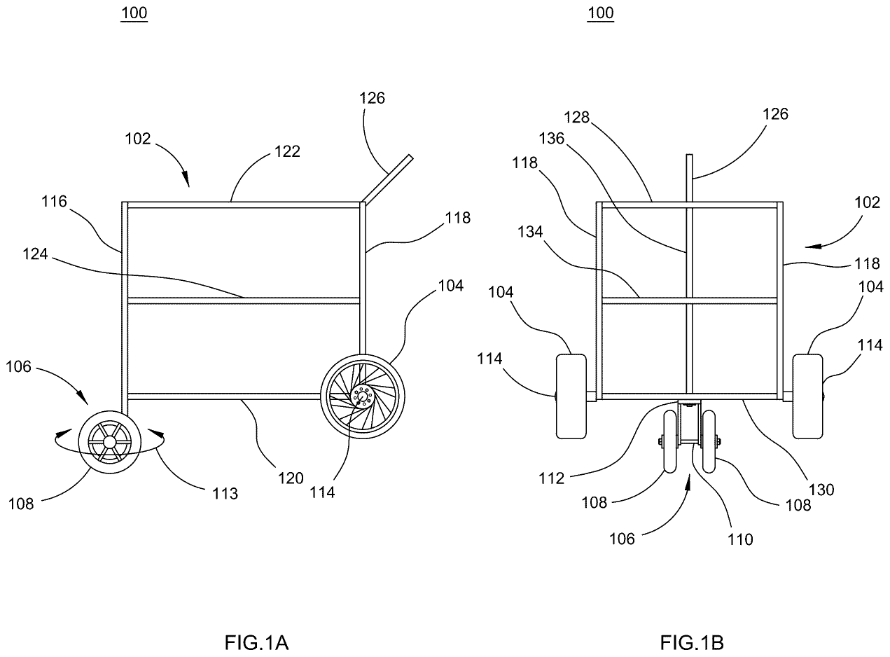

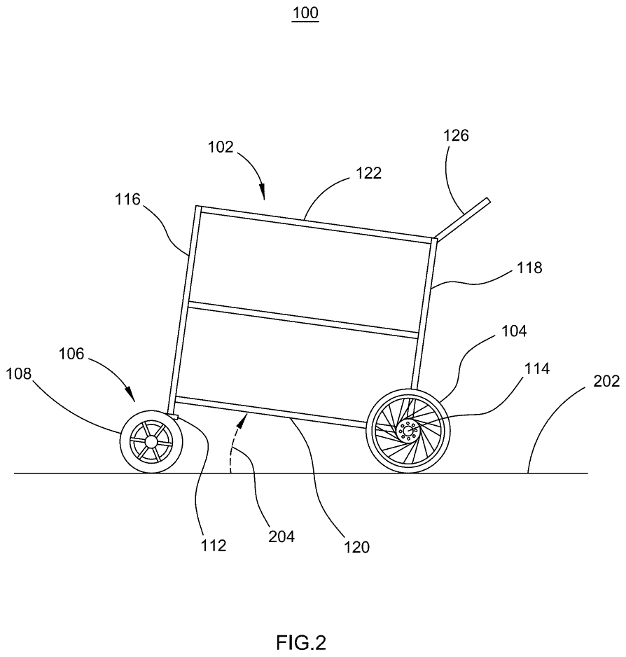

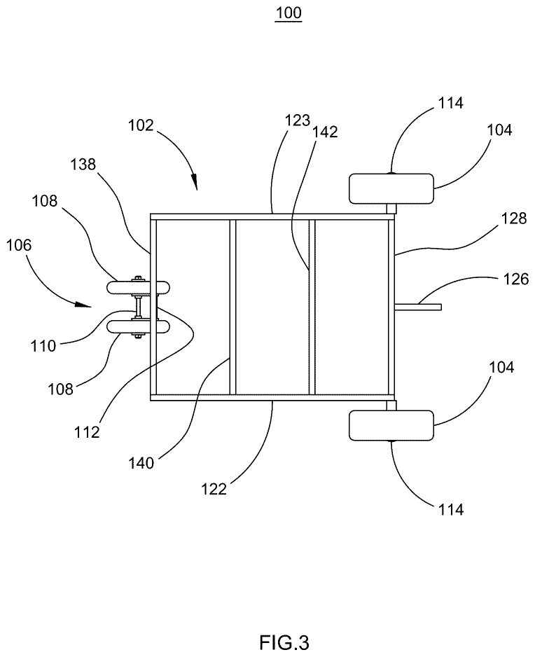

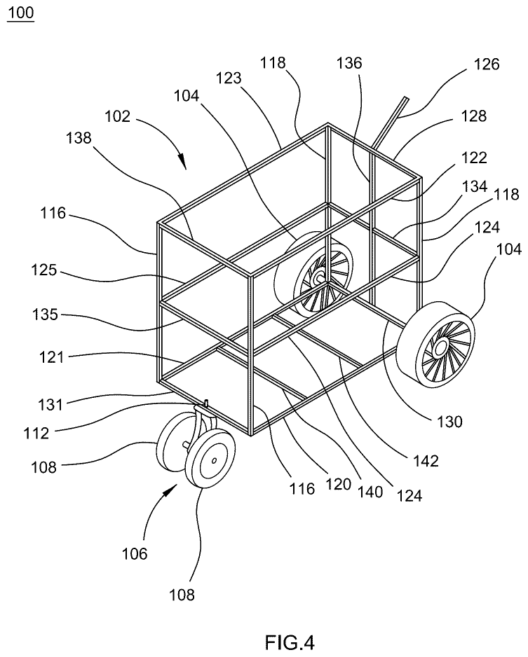

FIG. 1A a side elevational view of a multi-purpose cart 100, in accordance with some embodiments. The multi-purpose cart 100 is likewise shown in the subsequent drawings as well, and the reference numerals are carried forward throughout the drawings. In FIGS. 1A and 1B, the multi-purpose cart 100 is shown with the frame 102 level, even though the rear wheels 104 and front wheels 108 are at different levels. FIGS. 2-4 show other view of the cart 100 and should be referenced as well in the following description. In some embodiments the real wheels 104 and front wheels 108 can be at the same level such that the frame 102 will be level when both the rear wheels 104 and front wheels 108 on a level surface. The rear wheels 108 are connected to an axle 114 that can pass through a lower transverse frame member 130. In general, the frame members can be tubular members or hollow cylindrical members that are connected together.

The frame portion 102 includes a pair of vertical front frame members 116 on opposite sides of the frame 102, and which extend from the bottom to the top of the frame 102. Similarly, there are two vertical rear frame member 118 at opposite sides of the frame 102, and which also extend from the bottom of the frame 102 to the top of the frame 102. These vertical frame members 116, 118 establish the corners of the frame 102. At the front of the frame 102, there is a top front cross frame member 138 that connects the top of each of the vertical front frame members 116. There is also a middle front cross frame member 135 and a bottom front cross frame member 131. The middle front cross frame member 135 connects to each of the vertical front frame members approximately midway, in the vertical direction, between the top front cross member 138 and the bottom front cross frame member 131, which connects to the bottom of each of the vertical front frame members 116. As used here, the term “cross” refers to a direction from one side to the opposite side of the cart 100, in the way that cross members 138, 135, and 131 are oriented in the longitudinal direction. The side members extend in a direction from back to front. At the rear of the frame 102, there is top rear cross member 128 that connects to the top of each of the vertical rear frame members 118. There is also s middle rear cross member 134 and a bottom rear cross member 130. Along the left side there is a left side top member 122, a left side middle member 124, and a left side bottom member 120. Each of the left side members 120, 122, 124 extend from the left rear vertical member 118 to the left front vertical member 116, connecting to corresponding positions on the vertical members 116, 118. Along the right side there is a right side top member 123, a right side middle member 125, and a right side bottom member 121. Each of the left side members 121, 123, 125 extend from the right rear vertical member 118 to the right front vertical member 116, connecting to corresponding positions on the vertical members 116, 118. The are also intermediate bottom cross members 140, 142 which connect to the left and right side bottom member 120, 121. At the rear top cross member 128 there is a handle extension 126 which extends upwards and to the rear, and is further supported by a rear middle vertical member 136 which connects to the rear top cross member 128, rear middle cross member 134, and rear bottom cross member 130 at generally central locations. In general, the frame 102 defines an interior volume that is bounded by the front, rear, left, and right sides, and the bottom. As will be shown, material can be added to these sides to allow placing items into the frame 102.

The front wheel assembly 106, which includes the front wheels 108, includes a central armature 110 through which an axle passes at the bottom of the armature 110 for each of the front wheels 108. The armature 110 is connected to the middle of the front bottom cross member 131 at a pivot assembly 112, and allows the armature 110 to turn freely in the horizontal direction, as indicated by arrow 113. Thus, a person pushing the cart 100 from the rear, such as by using the handle extension 126, can direct the cart as desired, and the front wheel assembly 106 will turn at the pivot assembly 112 accordingly. As can be seen in the drawings, the front wheel 108 extend downward further than the rear wheels 104. As a result, as shown in FIG. 2, when the cart 100 is placed on a surface 202, the cart 100 is tilted at an angle 204. This encourages the user to place items in the cart 100 to the rear of the cart 100 first, thereby preventing the cart 100 from being front heavy.

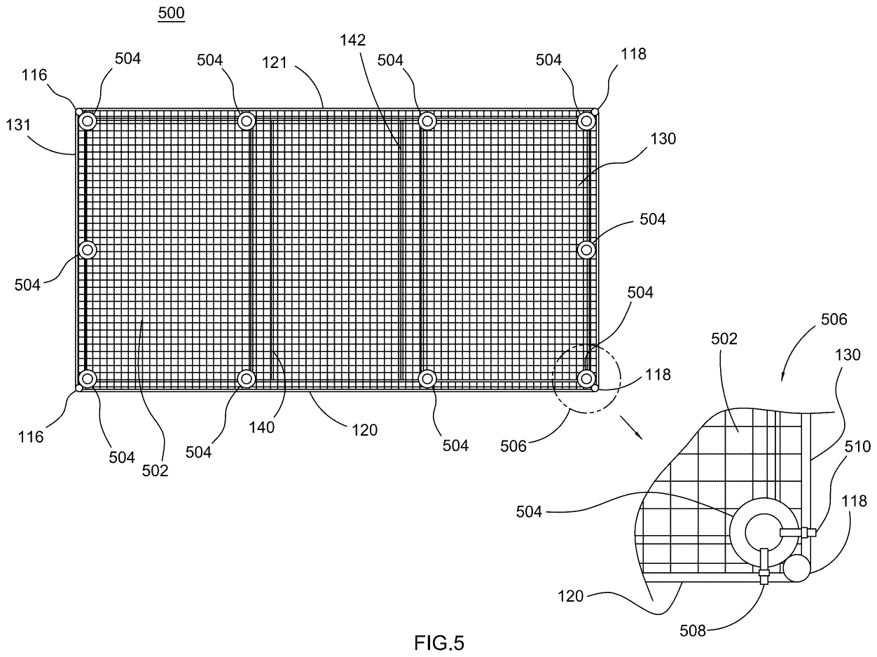

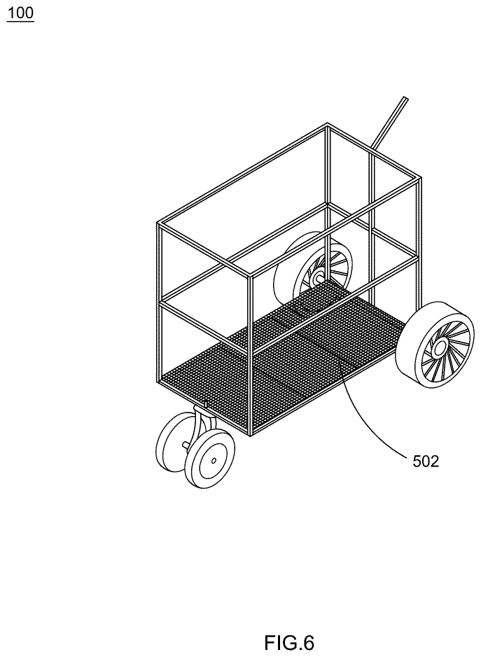

FIG. 5 is a top plan view of a mesh bottom panel 502 attached to the lower or bottom frame members of the frame 102 of the multi-purpose cart 100, in accordance with some embodiments. The panel 502 can be sized and shaped to cover the bottom of the frame, from the left side to the right side, and from the front to the rear. The hold the panel 502 in place, the panel can have grommets 504 along the sides of the panel 502 and at the corners of the panel 502. As seen in the inset 506 showing a detail of a corner, cable ties 508, 510 can be used to secure the panel 502 to the frame 102. Alternatively, there can be hooks disposed on the bottom frame members at the corresponding locations of the grommets that pass through the grommets 504 to hold the panel 502 in place. In some embodiments, rather than a mesh panel 502, and thin board member can be used that rests on the bottom frame members 120, 121, 130, 131, 140, 142. FIG. 6 shows the cart 100 with the mesh panel 502 installed.

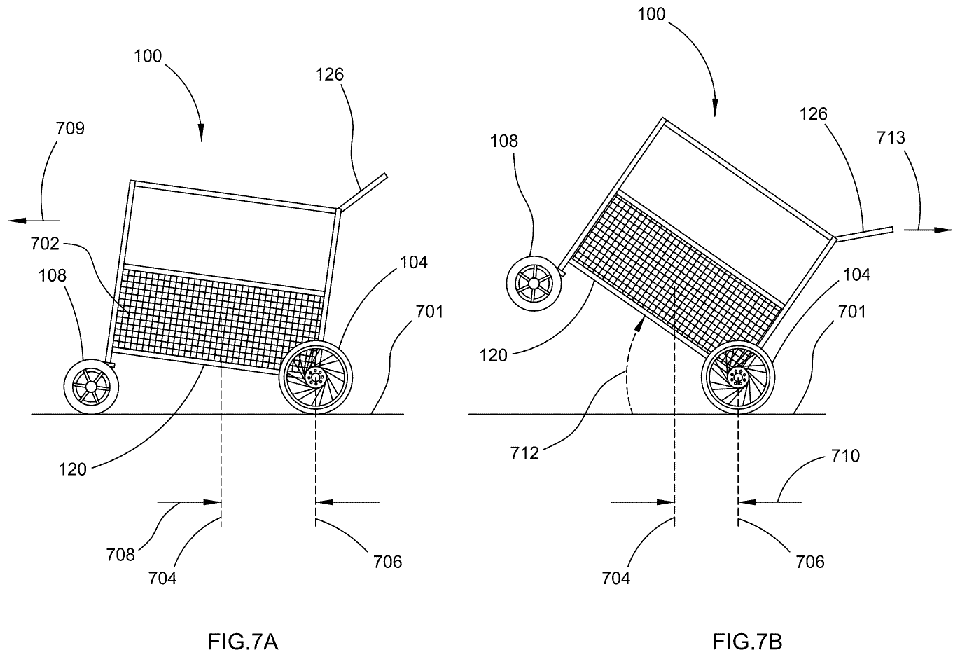

FIG. 7A is a side elevational view of the multi-purpose cart 100 resting on a level surface 701, for use as a cart, in accordance with some embodiments. In this view, it can be seen that side panels such as left lower side panel 702 can be added to the frame to hold the contents of the cart 100 in the frame. The cart 100 can be pushed by user to carry items, and the user can add items to the cart 100. As can be seen here, and in FIG. 2, the front wheels 108 are entirely below the bottom frame members, allowing the wheel assembly 106 to pivot fully, three hundred and sixty degrees, under the frame. When both the front wheels 08 and rear wheels 104 are on the ground 701, the cart 100 can be pushed forward, in the direction of arrow 709. Further, because the front wheels 104 extend downward, relative to the frame (when the frame is at a level position), further than the rear wheels 104, the frame is tilted toward the rear. This means, for example, that the front end of the left side bottom frame member 120 is further from the ground 701 than is the rear end, and the rest of the frame is tilted accordingly. For a given load in the cart, there is a center of gravity 704 that is located between the front and rear wheels 108, 104, respectively, which is a horizontal distance 708 from the center 706 of the rear wheels 104. By tilting the cart as shown, items placed in the cart will tend to be located toward the back/rear of the cart 100, making pushing the cart 100 easier than if the cart 100 were front-heavy (e.g. all the items loaded towards the front).

In FIG. 7B, the cart 100 has been tilted further, such that the front wheels 108 are now off the ground 701, and frame is tilted at a further angle 712. The angle 712 can be about a forty five degree angle, between the ground and the bottom side frame members (e.g. 120). As a result, the vertical projection of the center of gravity 704 is shifted to the rear, and horizontal distance 710 between the center of gravity 704 and the center 706 of the of the rear wheels 104 are closer together. This makes pulling the cart 100 from the handle extension 126 to the rear, in the direction of arrow 713, such as when the cart 100 is pulled as a trailer, easier. If the front wheels 108 were on the ground when being pulled in the direction of arrow 713, the cart 100 could weave side to side, thus it is preferrable to lift the front wheels 108 off the ground, as well as to reduce the horizontal distance between the center of gravity and axle of the rear wheels 104 as it reduces the tendency of the cart to oscillate from side to side. As is well known, when pulling a trailer that has one axle (or two wheels), if the center of gravity is behind the wheels, relative to the direction the trailer is being pulled, side to side oscillations can grow in amplitude with each oscillation. This can, and has caused loss of control of the pulling vehicle. If the center of gravity is ahead of the wheels, the tendency to oscillate is dampened. Thus, by tilting the cart for towing as a trailer, the center of gravity of the load is moved closer to the rear wheels 104, reducing the tendency of the trailer to oscillate.

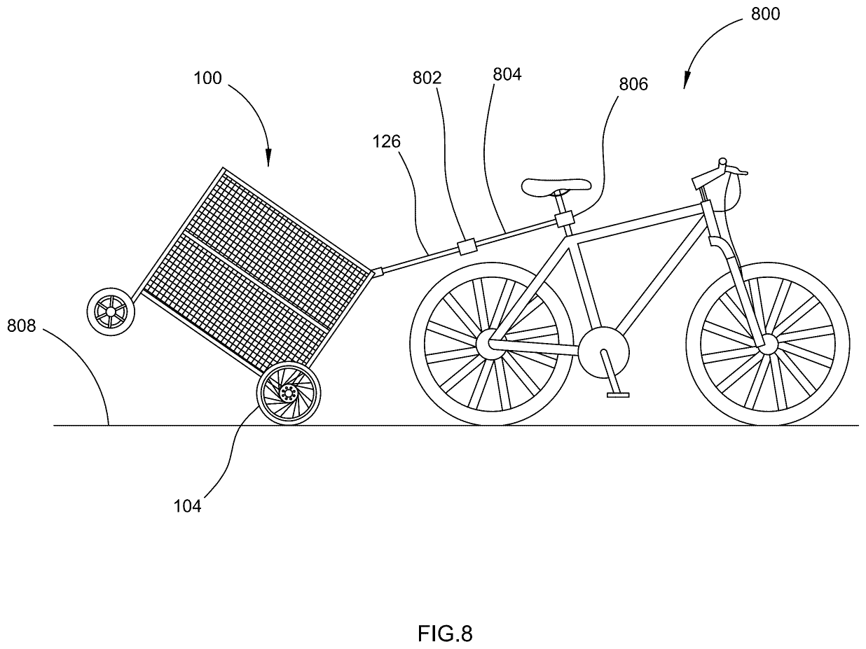

FIG. 8 shows the multi-purpose cart 100 used as a bicycle trailer, in accordance with some embodiments. The cart 100 is coupled to a bicycle 800 by, for example, attaching the handle extension 126 to a trailering arm 804 through a connector 802. Specifically, the distal end of the handle extension 126 (opposite the end connected to the top rear cross member 128) is configured to couple to the connector 802. The connector 802 can be a quick disconnect type connector that allows the end of the handle extension 126 to couple to the trailering arm 804. The other end of the trailering arm 804 can be attached to the seat stem at a pivot coupling 806 that allows the trailering arm 804 to move side to side. The range of motion that the trailering arm 804 can pivot can be limited to further dampen any tendency of the cart to oscillate when being pulled as a trailer. In other embodiments the trailering arm 804 can be connected to a rack at the back end of the bicycle 800. The trailering arm 804 is rigid, and the connector 802 is designed to keep the cart 100 in the tilted orientation at the desired angle of tilt so that the weight of the cart is shifted towards the rear wheels 104, and only the rear wheels 104 make contact with the ground surface 808, preventing the front wheels from touching ground and making pulling the cart difficult.

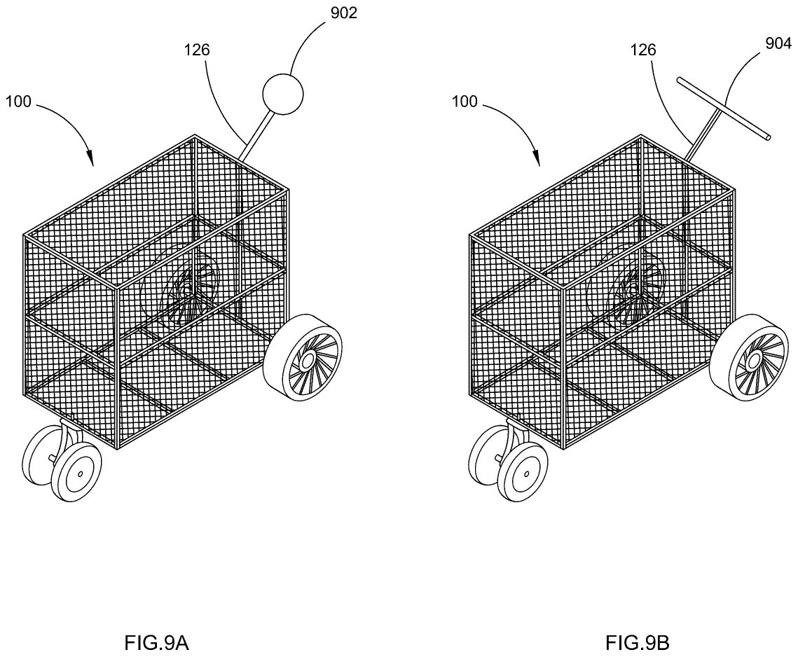

FIGS. 9A and 9B show perspective views of the multi-purpose cart as part of a multi-purpose cart system, with different handle types for pushing the multi-purpose cart, in accordance with some embodiments. The handles are used when the multi-purpose cart is being pushed by a person, as a push cart, while walking behind the multi-purpose cart. As shown in FIG. 8, the multi-purpose cart can also be pulled as a trailer using a different type of attachment to the handle extension 126. The handle extension 126 is terminated with a fitting that is configured to both connect to the connector 802 to trailer the cart 100, as well as to accept and connect to a handle or several different types of handles. For example, in FIG. 9A the handle is a spherical handle 902 that connects to the handle extension 126 at the end of the handle extension 126. In FIG. 7B a bar-type handle 904 is shown connected to the distal end of the handle extension 126. The bar-type handle is a longitudinal member that can be oriented parallel to the horizontal frame members. It should also be noted that in FIG. 9A-9B the frame is shown with mesh panels covering all of the sides, including the front and rear sides as well as the left and right sides. The use of mesh panels helps keep the cart 100 light, and therefore easy to push and pull, and even to carry.

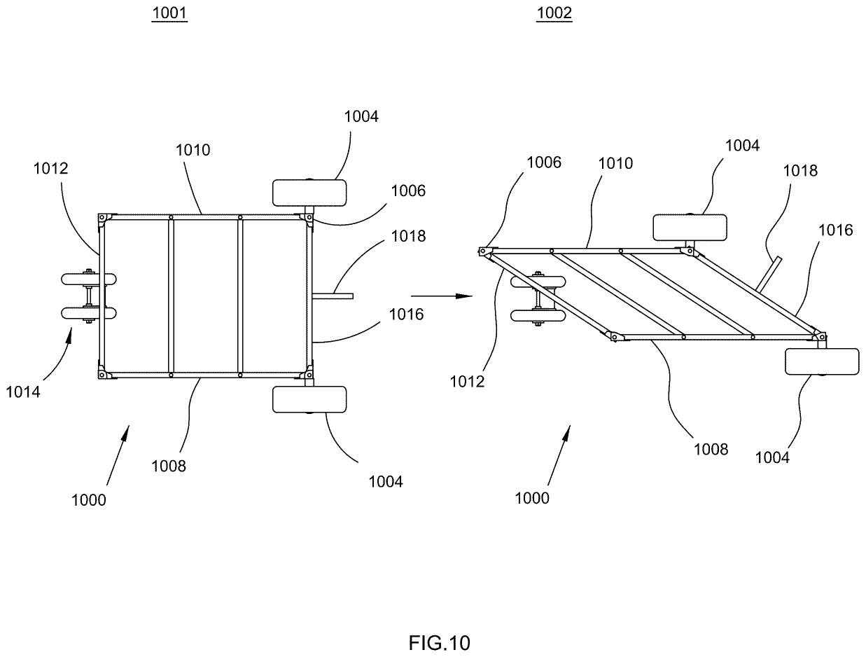

FIG. 10 shows top plan views of a multi-purpose cart 1000 that is configured to fold, in an unfolded state 1001 and a folded or partially folded state 1002, in accordance with some embodiments. The cart 1001 is very similar to cart 100, having a similar frame and wheels in similar locations. Cart 1000 includes two rear wheels 1004 that are each on an independent respective axle that extends outward from the frame of the cart 1000. The rear wheels 1004 are positioned to the sides of the frame of the cart 1000, rather than, for example, under the frame of the cart 1000. The front wheel assembly 1014 can be mounted to the bottom front cross frame member as in cart 100. The frame includes a left side 1008, right side 1010, front side 1012, and rear side 1016. The sides 1008, 1010, 1012, 1016 are defined by the respective frame members at each side 1008, 1010, 1012, 1016, and can include upper (top), middle, and lower (bottom) frame members similar to cart 100.

To facilitate folding, such as for storage of the multi-purpose cart 1000 when not in use, the cart 1000 includes locking hinge joints 1006 at each of the four corners of the frame. There can be upper, middle, and lower hinge joints 1006 at each corner for the respective upper, middle, and lower frame members connected at adjacent sides of the frame. The hinge joints 1006 can be locked so that they do not allow movement of the respective frame members to which they are connected, and then unlocked to allow folding of the cart as in the folded state 1002. The lock in each of the hinge joints and simply be a screw mechanism that tightens of loosens the hinge joint, or it can be, for example, a spring-biased lock that rigidly holds the two adjacent frame members but which can be unlocked by moving the spring-biased locking member against the spring force.

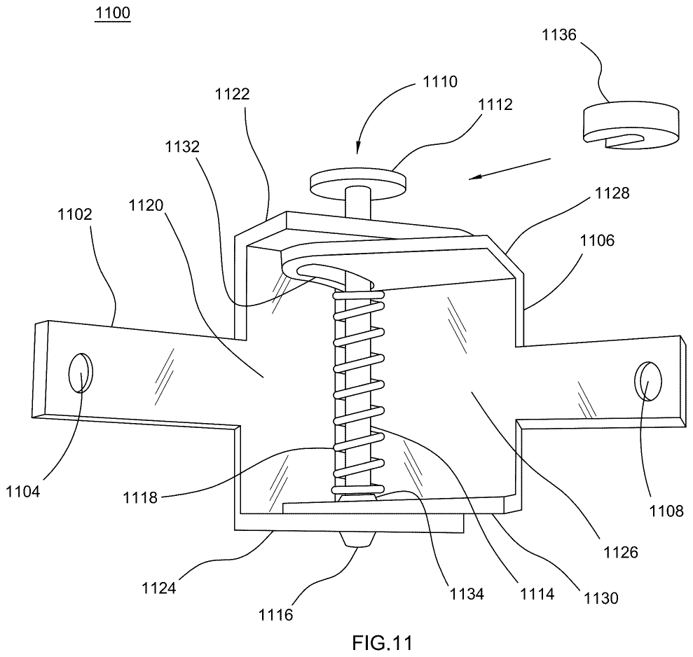

FIG. 11 shows a locking hinge 1100 for connecting frame members of a multi-purpose cart that allow the multi-purpose cart to be folded as well as locked into an unfolded state for use, in accordance with some embodiments. The hinge 1100 includes a first section 1102 and a second section 1106. The first section 1102 can be coupled to a first frame member, such as by a fastener through opening 1104 in a vertically planar portion 1120 and coupling to the frame member. The second section 1106 can be coupled to an adjacent frame member by a fastener passing through opening 1108 in its vertically planar portion 1126 and connecting to the adjacent frame member. The frame members to which the first and second sections 1102, 1106 are coupled are horizontal frame members that meet at a corner of the frame, at a vertical frame member. One of the sections 1102, 1106 can be further coupled to the vertical frame member at the respective corner. The first section further includes an upper horizontally planar portion 1122 and a lower horizontally planar portion 1124. The second section 1106 likewise includes an upper horizontally planar portion 1128 and a lower horizontally planar portion 1130 that are within the horizontally planar portions 1122, 1124 of the first section 1102. A post 1110 passes through opening the upper horizontally planar portions 1122, 1128. The upper planar portion 1128 includes an arcuate slot 1132 through which the post 1110 passes. The post 1110 includes a head 1112 that allows a user to grasp and lift the post 1110. The post 1110 further includes a body 1114 that extends from the head 1112 through the hinge, and specifically through the horizontally planar portions 1122, 1124, 1128, 1130. The lower planar portion 113 does not have an arcuate slot and only a simple circular opening to prevent the two sections 1102, 1106 freely moving relative to each other about the post 1110. A spring 1118 bears against a spring stop 1134 on the body 1114 of the post 1110 to bias the post 1110 downward such that the tip 1116 extends through the lower planar portion 1124. In the position shown, the locking hinge 1100 would be locked in a ninety degree configuration such as when the cart is in the unfolded state 1001 for use. To fold the cart, the user can pull up on the post 1110 such that the tip 1116 is raised above and clear of the lower horizontally planar portions 1124, 1130. With the post 1110 so raised, the two sections 1102, 1106 can move relative to each other, opening up to a one hundred eighty degree configuration to allow the frame of the cart to be folded, as in the folded state 1002. Given that there are several such locking hinges that need to be manipulated to fold the cart, a clip 1136 can be placed under the head 1112 to hold the post in the raised position; thus, a clip 1136 can be likewise placed at each locking hinge to hold it in an unlocked state to allow the frame of the cart to be folded. Other types of locking hinges can be used equivalently.

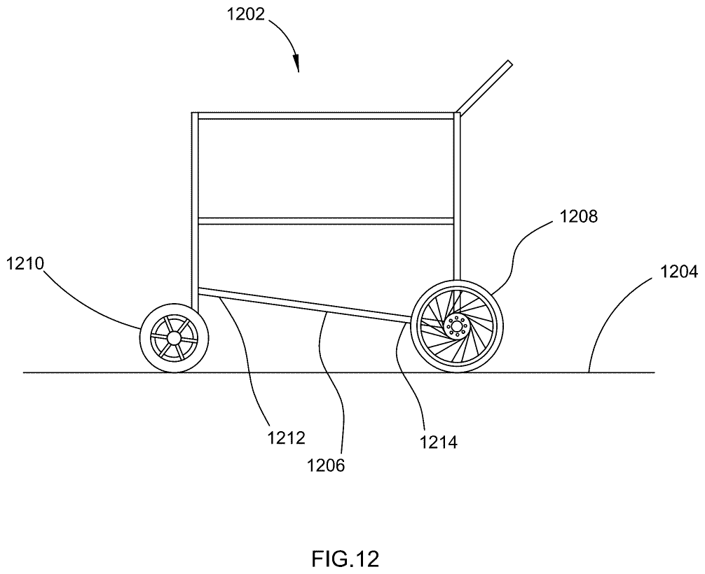

FIG. 12 shows a side elevational view of a multi-purpose cart 1200 having a sloping bottom 1206, in accordance with some embodiments. The cart 1200 sits on a level surface 1204, with both the rear wheels 1208 and front wheel 1210 on the surface 1204. Rather than having the front wheels extend downward, relative to the frame, than the rear wheels, as in cart 100, cart 1200 instead uses a downward sloping bottom, where the front end 1212 of the bottom 1206 is higher than the rear end 1214 of the bottom 1206. The angle of the bottom 1206 to level ground 1204 can be on the order of fifteen to twenty five degrees. The sloping bottom, as in cart 100, tends to encourage users to place items toward the rear of the cart 1200, which makes pulling the multi-purpose cart 1200 as a trailer easier.

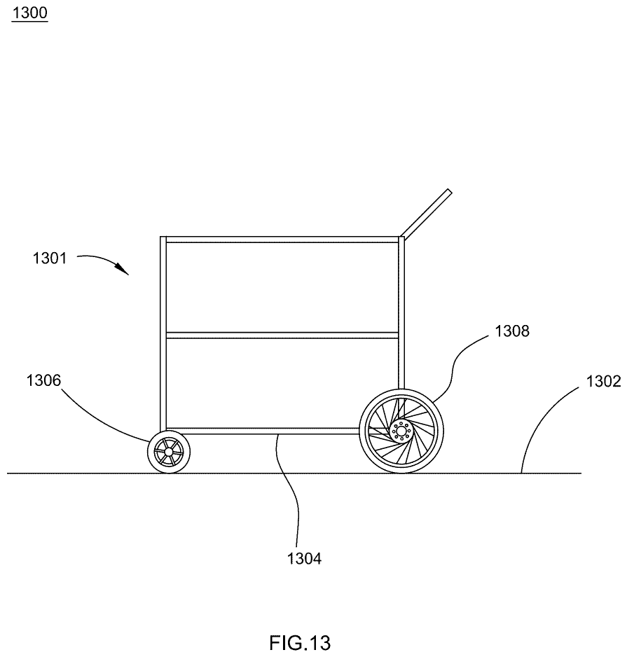

FIG. 13 shows a side elevational view of a multi-purpose cart 1300 that can be adjusted so that the frame 1301 of the cart 1300 is level when used as a push cart, in accordance with some embodiments. In some embodiments, when the cart 1300 is on a surface 1302 with both the front wheel 1306 and rear wheels 1308 on the surface 1302, the bottom 1304 of the frame 1301 can be parallel or level with the ground surface 1302. It is contemplated that in some embodiments the front wheel assembly can be height-adjustable so that the user can adjust the height of the front end of the cart 1300, and thereby the angle of the bottom 1304 of the frame 1301 to the ground surface 1302. There are numerous mechanisms by which the front wheel assembly can be made height-adjustable known in the art.

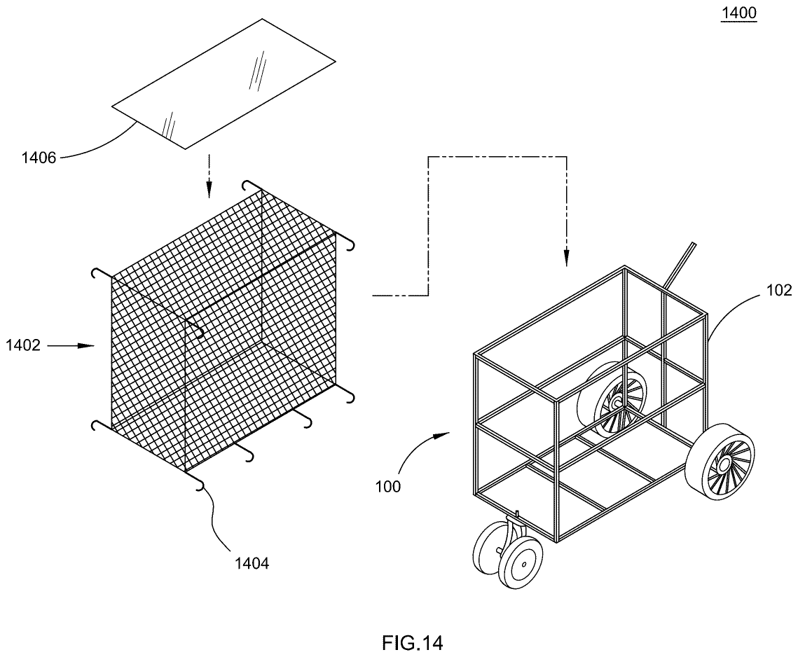

FIG. 14 shows a perspective view of a multi-purpose cart 100 in which a frame liner 1402 is used to line the frame 102 of the cart 100 and contain items within the frame 102, in accordance with some embodiments. The frame liner 1402 is sized to fit within the frame 102, and includes a bottom and sides that are supported by the frame member when the frame liner 1402 is placed into the frame 102. The frame liner 1402 can be a mesh or fabric material that can be folded or rolled up when not in use. The frame liner 1402 can include frame attachments 1404 that are connected to the frame liner 1402 and which can attach to frame members to hold the frame liner 1402 in place and to provide support for the frame liner 1402 when in the frame 102 of the cart. The attachments 1404 can be, for example, hooks that hang over the frame members, or hook and loop type strips to wrap around the frame members, among other examples of attachments. In some embodiments one or more rigid panels 1406 can be placed into the liner 1402 for additional support, if so desired. In some embodiments the liner 1402 can include a wire frame to support the fabric, in which case the attachments 1404 may not be necessary.

A multi-purpose cart has been disclosed which provides the benefit of being useful both as a conventional push cart, as well as a trailer that can be pulled behind, for example, a bicycle. When used as a push cart, the front wheels are on the ground, and they can freely pivot or rotate horizontally to allow steering of the cart. When used as a trailer, only the rear wheels are on the ground, and the coupling linkage to the bicycle (or whatever is pulling the cart) is configured to keep the cart tilted and maintain the front wheels off the ground, as well as to move the center of gravity of the cart (and its load) toward the rear wheels.

The claims appended hereto are meant to cover all modifications and changes within the scope and spirit of the present invention.

1. A multi-purpose cart that is operable alternatively as a push cart and as a bicycle trailer, comprising:
a frame that defines a first side, a second side that is opposite the first side, a front end, a rear end that is opposite the front end, wherein the first side and the second side extend from the front end to the rear end, the frame also defining a bottom, and wherein a top of the frame is open;
a first rear wheel disposed at a bottom of the first side at the rear end, a second rear wheel disposed at a bottom of the second side at the rear end and opposite the first rear wheel;
a front wheel assembly including at least one front wheel at a bottom of the front end, and which is configured to freely turn in a horizontal direction;
a handle extension rigidly attached to and distinct from the frame, which extends upward and to the rear from a top cross member of the rear end, at a center of the top cross member, and has a distal end;
a handle configured to detachably attach to the distal end of the handle extension to operate the multi-purpose cart as a push cart;
a trailering arm configured to detachably attach to the distal end of the handle extension, alternatively with, and instead of, the handle to operate the multi-purpose cart as a trailer, via a connector, wherein when the trailering arm is connected to the handle the trailering arm is positioned such that the trailering arm extends away from the multi-purpose push cart at the rear end of the push cart, and wherein when the trailering arm is attached to the handle extension and to a bicycle, the frame is tilted such that the front end of the frame is elevated and the front wheel assembly does not make contact with a ground surface; and
wherein the bottom of the frame defines a plane between the first side and the second side and from the front end to the rear end and that slopes downward from the front end to the rear end relative to the multi-purpose cart being on a level surface with the at least one front wheel and the first and second rear wheels being on the level surface to encourage placement of items toward the rear end for improved weight distribution and to reduce oscillations of the multi-purpose cart when the multi-purpose cart is operated as a trailer, and such that a bottom panel covering the bottom of the frame, from the front end to the rear end and from the first side to the second side, lies in a plane that is parallel to the plane defined by the bottom and also slopes downward from the front end to the rear end.

2. The multi-purpose cart as claimed in claim 1, wherein the at least one front wheel extends downward, relative to the frame, further than the first and second rear wheels.

3. (canceled)

4. The multi-purpose cart as claimed in claim 1, wherein the frame is comprised of a plurality of tubular members including at least one front vertical member, and a first rear vertical member defining a first corner where the first side and the rear end meet, and a second rear vertical member that is opposite the first rear vertical member and which defines a second corner where the second side and the rear end meet.

5. The multi-purpose cart as claimed in claim 1, wherein the bottom panel is a mesh panel that covers the bottom of the frame.

6. The multi-purpose cart as claimed in claim 5, further comprising at least one mesh panel on the first side of the frame, at least one mesh panel on the second side of the frame, at least one mesh panel on the front end of the frame, and at least one mesh panel on the rear end of the frame.

7. The multi-purpose cart as claimed in claim 1, wherein the front wheel assembly comprises two front wheels disposed on opposite sides of an armature that is connected to a front bottom cross member of the frame via a pivot assembly.

8. A multi-purpose cart system including a multi-purpose cart that can be used in a first mode as a push cart and in a second mode as a bicycle trailer, the system comprising:
a multi-purpose cart, including:
a frame that defines a first side, a second side that is opposite the first side, a front end, a rear end that is opposite the front end, wherein the first side and the second side extend from the front end to the rear end, the frame also defining a bottom surface, and wherein a top of the frame is open, the bottom of the frame defining a plane between the first side and the second side and from the front end to the rear end that slopes downward from the front end to the rear end;
a bottom panel that covers the bottom of the frame from the front end to the rear end and from the first side to the second side in a plane that is parallel to the plane defined by the bottom of the frame;
a first rear wheel disposed at a bottom of the first side at the rear end, a second rear wheel disposed at a bottom of the second side at the rear end and opposite the first rear wheel;
a front wheel assembly including at least one front wheel at a bottom of the front end, and which is configured to freely turn in a horizontal direction;
a handle extension rigidly attached to and distinct from the frame, which extends upward and to the rear from a top of the rear end;
a handle configured to detachably attach to a distal end of the handle extension when the multi-purpose cart is used as a push cart; and
a trailering arm that detachably attaches, via a connector, directly to the distal end of the handle extension, alternatively with and instead of the handle, at a first end of the trailering arm, and to a bicycle at a second end of the trailering arm when the multi-purpose cart is used as a bicycle trailer, and wherein the trailering arm maintains the multi-purpose cart in a tilted orientation relative to when the multi-purpose cart is used as a push cart when the trailering arm is further coupled to a bicycle such that the front end of the cart is elevated relative to when the multi-purpose cart is used as a pushcart and only the first and second rear wheels make contact with a ground surface over which the multi-purpose cart is pulled via the trailering arm.

9. The multi-purpose cart system of claim 8, wherein the bottom of the frame slopes downward in a direction from the front end to the rear end relative to the multi-purpose cart being on a level surface with the at least one front wheel and the first and second rear wheels being on the level surface.

10. The multi-purpose cart system of claim 9, wherein the at least one front wheel extends downward, relative to the frame, further than the first and second rear wheels.

11. The multi-purpose cart system of claim 8, wherein the frame is comprised of a plurality of tubular members including at least one front vertical member, and a first rear vertical member defining a first corner where the first side and the rear end meet, and a second rear vertical member that is opposite the first rear vertical member and which defines a second corner where the second side and the rear end meet.

12. The multi-purpose cart system of claim 8, wherein the bottom panels is a mesh panel that covers the bottom of the frame.

13. The multi-purpose cart system of claim 12, further comprising at least one mesh panel on the first side of the frame, at least one mesh panel on the second side of the frame, at least one mesh panel on the front end of the frame, and at least one mesh panel on the rear end of the frame.

14. The multi-purpose cart system of claim 8, wherein the front wheel assembly comprises two front wheels disposed on opposite sides of an armature that is connected to a front bottom cross member of the frame via a pivot assembly.

15. The multi-purpose cart system of claim 8, wherein the frame of the multi-purpose cart includes locking hinges that lock the frame in an unfolded state for use as a push cart and as a trailer, and which unlock to allow the frame to be folded for storage.

16. A multi-purpose cart operable alternatively as a push cart and as a trailer, comprising:
a frame that defines a first side, a second side that is opposite the first side, a front end, a rear end that is opposite the front end, wherein the first side and the second side extend from the front end to the rear end, the frame also defining a bottom, and wherein a top of the frame is open, the bottom of the frame defining a plane between the first side and the second side and from the front end to the rear end that slopes downward from the front end to the rear end at an angle of fifteen to twenty five degrees relative to a level surface;
a bottom panel that covers the bottom of the frame from the front end to the rear end and from the first side to the second side in a plane that is parallel to the plane defined by the bottom of the frame, wherein the slope of the bottom encourages placement of items toward the rear end for improved weight distribution and to reduce oscillations of the multi-purpose cart when the multi-purpose cart is operated as a trailer;
a first rear wheel disposed at a bottom of the first side at the rear end; a second rear wheel disposed at a bottom of the second side at the rear end and opposite the first rear wheel;
a front wheel assembly including at least one front wheel at a bottom of the front end, and which is configured to freely turn in a horizontal direction;
a handle configured to detachably connect to the rear end of the frame when the multi-purpose cart is operated as a push cart; and
a trailering arm configured to detachably connect to the rear end of the frame, alternatively with and instead of the handle, and extend in a direction to the rear of the frame when the multi-purpose cart is operated as a trailer, and wherein when the trailering arm is further coupled to a bicycle, the frame is tilted such that the front end is raised relative to when the multi-purpose cart is used as a push cart and the front wheel assembly is raised off a ground surface on which the first rear wheel and the second rear wheel are on.
